(19) United States
(12) Patent Application Publication
(10) Pub. No.: US 2022/0044414 A1
(43) Pub. Date: Feb. 10, 2022

(54) METHOD AND DEVICE FOR PROCESSING IMAGE ON BASIS OF ARTIFICIAL NEURAL NETWORK

(71) Applicant: KOREA ADVANCED INSTITUTE OF SCIENCE AND TECHNOLOGY, Daejeon (KR)

(72) Inventors: Junyong NOH, Daejeon (KR); Kwanggyoon SEO, Daejeon (KR); Hyunggoog SEO, Daejeon (KR); Sanghun PARK, Daejeon (KR); Jaedong KIM, Daejeon (KR); Jung Eun YOO, Daejeon (KR); Dawon LEE, Daejeon (KR)

(21) Appl. No.: 17/275,772

(22) PCT Filed: Feb. 21, 2019
(86) PCT No.: PCT/KR2019/002099

§ 371 Date: Mar. 12, 2021

(30) Foreign Application Priority Data
Oct. 18, 2018 (KR) 10-2018-0124256
Feb. 20, 2019 (KR) 10-2019-0019620

(51) Int. Cl. G06T 7/194; G06T 7/80; G06K 9/62; G06N 3/04

(52) U.S. Cl. CPC G06T 7/194; G06N 3/0454; G06K 9/6212; G06T 7/80

(57) ABSTRACT

Disclosed are a method and apparatus for processing an image based on an artificial neural network. The method separates an input image into a foreground image including a subject and a background image including remaining objects except for the subject, estimates camera framing for the subject based on the input image and the foreground image, configures a feature vector based on an optical flow map extracted from the input image, estimates camera work using the feature vector, and outputs at least one selected from between the camera framing and the camera work.

### TECHNICAL FIELD

One or more example embodiments relate to image processing technology for classifying camera framing and camera work from an input image using a neural network.

### BACKGROUND ART

Over-the-top (OTT) refers to a service that enables TV content to be viewed through the Internet. OTT may provide image content through the public internet, not through radio waves or cables. In OTT, “top” means a set-top box connected to a TV. However, OTT may be broadly construed as including all Internet-based video services, regardless of whether a set-top box is provided or not.

With the development and spread of high-speed Internet, video services are provided through the OTT service. In the OTT service, camera framing and grammar may be important factors in not only image production but also the edition and extraction process. Currently, editors and content creators may produce a thumbnail or short image suitable for content while viewing the entire image, or be provided with only limited output content through an automated system.

### DISCLOSURE OF INVENTION

### Technical Goals

According to an example embodiment, the inconvenience of a user having to view the entire image when producing content may be reduced through automatic camera framing and automatic camera work analysis based on an artificial neural network.

According to an example embodiment, a user may more easily edit an input image by separating the input image into a foreground corresponding to a main subject and a background through camera framing and camera work analysis.

According to an example embodiment, a highlight and a thumbnail of an image may be extracted through camera framing and camera work analysis, and the analysis results may be utilized for camera motion stabilization and image compression.

### Technical Solutions

According to an aspect, there is provided an image processing method including separating an input image into a foreground image including a subject and a background image including remaining objects except for the subject, estimating camera framing for the subject based on the input image and the foreground image, extracting an optical flow map from the input image, configuring a feature vector based on the optical flow map, estimating camera work using the feature vector, and outputting at least one selected from between the camera framing and the camera work.

The separating may include separating the input image into the foreground image and the background image using a first neural network that is trained in advance.

The first neural network may include a convolutional neural network (CNN).

The estimating of the camera framing may include extracting feature points of the subject from the input image based on information on the subject included in the foreground image, and estimating the camera framing for the subject from the feature points of the subject.

The subject may include a person, and the feature points of the subject may include at least one selected from among the eyes, nose, ears, neck, shoulders, elbows, wrists, pelvis, knees, and ankles of the person.

The camera framing may include at least one subject placement structure selected from among close-up, bust, medium, knee, full, and long.

The extracting may include extracting the optical flow map using a current frame corresponding to the input image and a frame previous to the current frame.

Pixels included in the optical flow map may each have a vector including a direction and a magnitude.

The configuring may include dividing the optical flow map into a plurality of areas using the rule of thirds, and configuring the feature vector based on vectors corresponding to at least one area selected from among the plurality of areas.

The configuring of the feature vector based on the vectors may include generating histograms for the respective areas using direction components of the vectors, and configuring the feature vector by integrating the histograms for the respective areas.

The estimating of the camera work may include estimating the camera work by applying the feature vector to a second neural network that is trained in advance.

The second neural network may be trained using a plurality of training images labeled with camera framing and camera work.

The second neural network may include a multi-layer perceptron (MLP) model.

The camera work may include at least one camera move selected from among pan, tilt, orbit, crane, track, and static.

According to an aspect, there is provided an image processing apparatus including a communication interface configured to receive an input image, and a processor configured to separate the input image into a foreground image including a subject and a background image including remaining objects except for the subject, estimate camera framing for the subject based on the input image and the foreground image, extract an optical flow map from the input image, configure a feature vector based on the optical flow map, and estimate camera work using the feature vector, wherein the communication interface may be further configured to output at least one selected from between the camera framing and the camera work.

The processor may be further configured to separate the input image into the foreground image and the background image using a first neural network that is trained in advance.

The processor may be further configured to extract the optical flow map using a current frame corresponding to the input image and a frame previous to the current frame.

The processor may be further configured to divide the optical flow map into a plurality of areas using the rule of thirds, generate histograms for the respective areas using direction components of vectors corresponding to at least one area selected from among the plurality of areas, and configure the feature vector by integrating the histograms for the respective areas.

### Effects

According to example embodiments, the inconvenience of a user having to view the entire image when producing content may be reduced through automatic camera framing and automatic camera work analysis based on an artificial neural network.

According to example embodiments, a user may more easily edit an input image by separating the input image into a foreground corresponding to a main subject and a background through camera framing and camera work analysis.

According to example embodiments, a highlight and a thumbnail of an image may be extracted through camera framing and camera work analysis, and the analysis results may be utilized for a camera motion stabilization and image compression algorithm.

### BRIEF DESCRIPTION OF DRAWINGS

FIG. 1 is a flowchart illustrating an image processing method according to an example embodiment.

FIG. 2 illustrates a method of separating a foreground image and a background image according to an example embodiment.

FIG. 3 illustrates a method of estimating camera framing according to an example embodiment.

FIG. 4 is a flowchart illustrating a method of configuring a feature vector according to an example embodiment.

FIG. 5 illustrates a method of configuring a feature vector using the rule of thirds according to an example embodiment.

FIG. 6 is a flowchart illustrating an image processing method according to another example embodiment.

FIG. 7 illustrates a method of training a second neural network according to an example embodiment.

FIG. 8 is a block diagram illustrating an image processing apparatus according to an example embodiment.

### BEST MODE FOR CARRYING OUT THE INVENTION

The following structural or functional descriptions are exemplary to merely describe the example embodiments, and the scope of the example embodiments is not limited to the descriptions provided in the present specification.

Various modifications may be made to the example embodiments in various forms. Thus, the example embodiments will be exemplarily shown in the drawings and described in detail in the present specification. Accordingly, the example embodiments are not construed as being limited to the disclosure and should be understood to include all changes, equivalents, and replacements within the technical scope of the disclosure.

Terms, such as first, second, and the like, may be used herein to describe components. Each of these terms is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected”, “coupled”, or “joined” to another component, a third component may be “connected”, “coupled”, and “joined” between the first and second components, although the first component may be directly connected, coupled, or joined to the second component. On the contrary, it should be noted that if it is described that one component is “directly connected”, “directly coupled”, or “directly joined” to another component, a third component may be absent. Expressions describing a relationship between components, for example, “between”, directly between”, or “directly neighboring”, etc., should be interpreted to be alike.

The terms used herein are for the purpose of describing particular example embodiments only and is not to be limiting of the example embodiments. The singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms including technical and scientific terms used herein have the same meaning as commonly understood by one of ordinary skill in the art to which example embodiments belong. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments will be described in detail with reference to the accompanying drawings. In the drawings, like reference numerals are used for like elements.

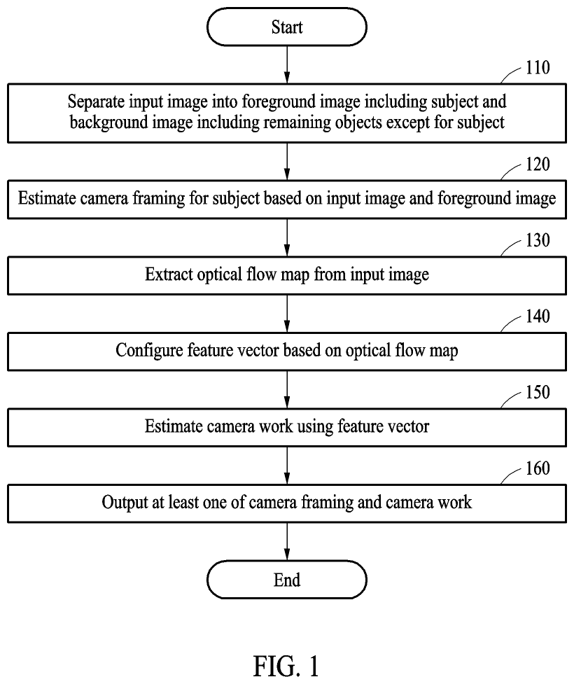

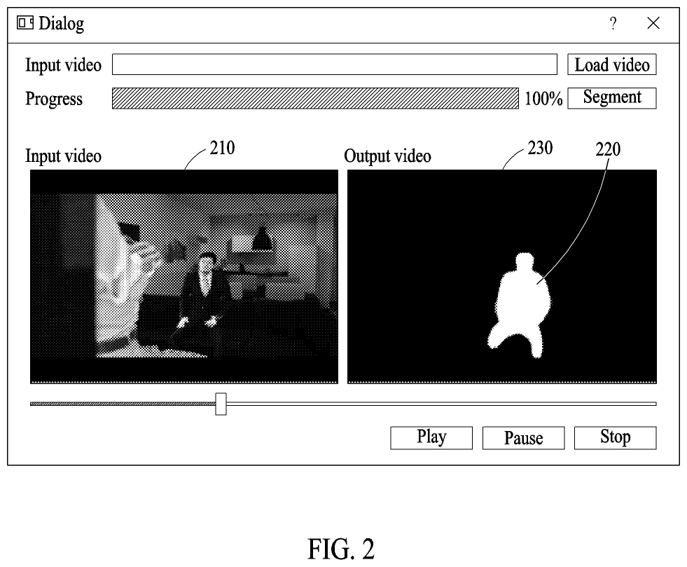

FIG. 1 is a flowchart illustrating an image processing method according to an example embodiment. Referring to FIG. 1, in operation 110, an image processing apparatus separates an input image into a foreground image including a subject and a background image including remaining objects except for the subject. The input image may include a plurality of frames. Here, the subject may be, for example, a person. There may be one or more subjects. The subject may also be referred to as “object of interest”. The method of separating the input image into the foreground image and the background image by the image processing apparatus will be described in detail below with reference to FIG. 2.

In operation 120, the image processing apparatus estimates camera framing for the subject based on the input image and the foreground image. “Camera framing” may refer to the screen composition of a camera, that is, composing a screen through a viewfinder from the beginning such that an image may be produced fully filling the film surface even without trimming the screen during photography. Camera framing may also be referred to as “camera composition”. Camera framing may include subject placement structures such as, for example, close-up, bust, waist, medium, knee, full, long, and the like.

Close-up enlarges only one part of an image, such as, for example, emphasizes the face of a person or highlights an object, may be mainly used to describe a psychological status such as tension, anxiety, or the like. A lively screen may be composed through a subject tightly framed by close-up.

Bust or bust shot places a subject from the chest up to the head on a screen and may be used for, for example, a scene of a conversation between people in movies or soap dramas, a scene of an interview in news or documentaries, and other various scenes.

Waist or waist shot places a subject from the waist up to the head on a screen and may be frequently used to show, for example, a motion of the upper body or a conversation scene and an interview scene.

Medium or medium shot may be a general term for shots including “bust-waist-knee shot” described above. For example, if shots are largely classified into three types: close-up shot, medium shot, and long shot, the medium shot may be one in the middle.

Knee or knee shot places a subject from the knee up to the head on a screen and may be used to capture, for example, a motion of the upper body of the subject or to capture several subjects. Knee shot may provide a sense of stability as providing an appropriate sense of distance.

Full or full shot places the entire appearance of a subject from the feet up to the head on a screen and may be used to show, for example, a person as a whole or a situation along with the background.

Long or long shot corresponds to a shot showing a subject from a distance. Long shot may be used as a means of describing the relationship between the subject and a photographer, their positions, or the like, and may be used as a means of aiming to provide visual effects. Further, long shot may be used to describe a situation when an event starts or a story at another location begins.

According to an example embodiment, the image processing apparatus may estimate the camera framing for the subject based on at least one selected from among the input image, the foreground image, and the background image. For example, the image processing apparatus may estimate the camera framing using a neural network 730, which will be described later.

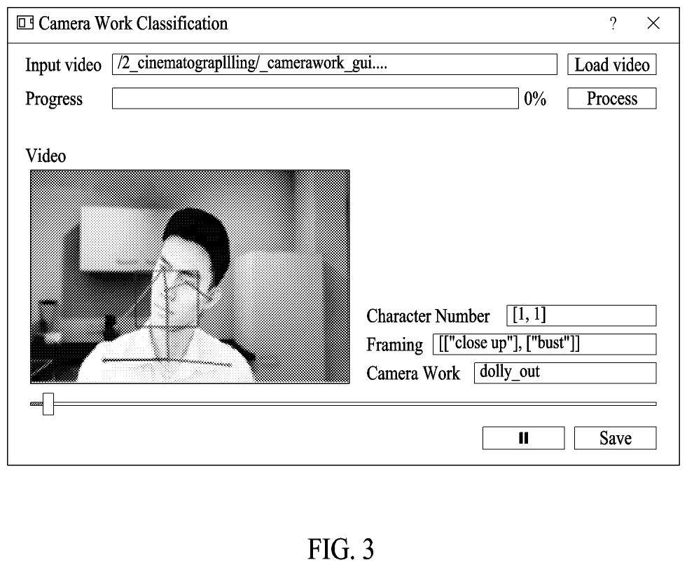

The method of estimating the camera framing by the image processing apparatus will be described in detail below with reference to FIG. 3.

In operation 130, the image processing apparatus extracts an optical flow map from the input image. “Optical flow”, the concept introduced to describe the visual stimulus, may be construed as the pattern of apparent motion of objects, surfaces, and edges in a visual scene caused by the relative motion between an observer and a scene. Optical flow may also be defined as the distribution of apparent velocities of motions of brightness pattern in an image.

The image processing apparatus may estimate a motion (information) between two frames without prior knowledge of a frame scene by using the optical flow map. Here, the motion (information) may be information indicating how the object of interest is moving (for example, the size of the motion, the direction of the motion, and the like).

For example, the image processing apparatus may extract the optical flow map using a current frame corresponding to the input image and a frame previous to the current frame.

The optical flow map may be, for example, a concentrated optical flow map. For example, the concentrated optical flow map may be generated based on an area in which the density of vectors constituting the optical flow map is higher than a preset criterion.

The velocity may be obtained from all the pixels in the image by using dense optical flow. An example of the dense optical flow is the Lucas-Kanade method. The Lucas-Kanade method may be based on three assumptions, such as i) brightness constancy assuming that a pixel on an object has a value that is constant even when a frame is changed, ii) time permanency assuming that the amount of movement of an object is not large between consecutive frames in an image, and iii) spatial coherence assuming that points spatially adjacent to each other are highly likely to belong to the same object and have the same motion.

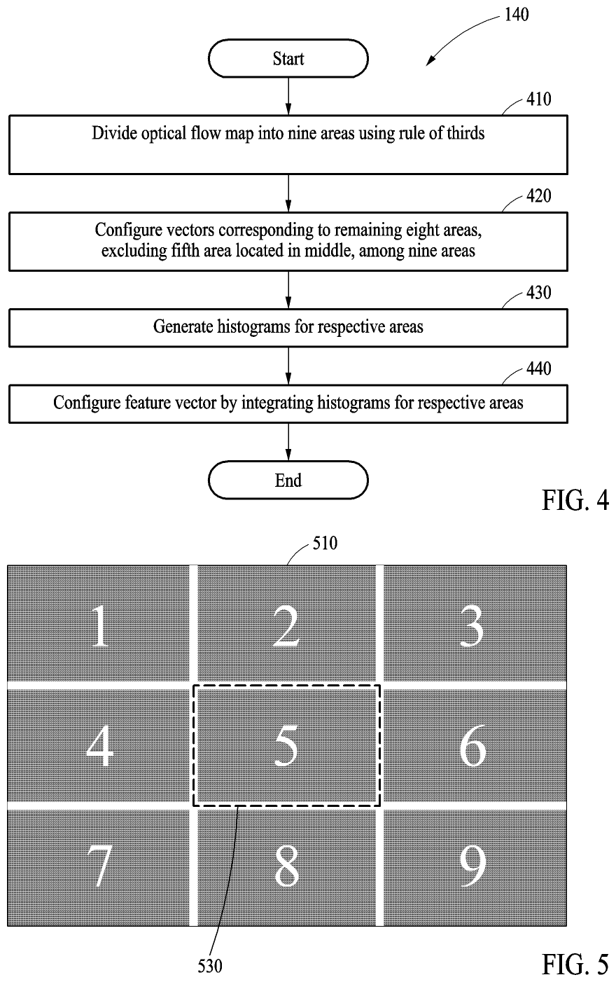

In operation 140, the image processing apparatus configures a feature vector based on the optical flow map. For example, the image processing apparatus may divide the optical flow map into a plurality of areas using the rule of thirds. The image processing apparatus may configure the feature vector based on vectors corresponding to at least one area selected from among the plurality of areas. The image processing apparatus may use the optical flow map to classify camera work. The method of configuring the feature vector by the image processing apparatus will be described in detail below with reference to FIG. 4.

In operation 150, the image processing apparatus estimates camera work using the feature vector. “Camera work” refers to a technique of photographing an image while fixing a camera or moving a lens, and may also be referred to as “camera grammar” or “camera move”. For example, the image processing apparatus may estimate the camera work by applying the feature vector to a second neural network that is trained in advance. For example, the second neural network may be trained using a plurality of training images labeled with camera framing and camera work. The second neural network may be, for example, the neural network 730, which will be described later. The second neural network may include, for example, a multi-layer perceptron (MLP) model. The MLP model is a type of feedforward artificial neural network and may include three nodes: an input layer, a hidden layer, and an output layer. In the MLP model, each node except the input node may be a neuron that uses a nonlinear activation function. MLP may be trained using supervised learning that is also referred to as backpropagation.

The second neural network and the first neural network may be the same neural network or different neural networks.

The image processing apparatus may train the MLP model using the feature vector configured in operation 140. The image processing apparatus may estimate the camera work by training the second neural network with virtual (computer graphics (CG)) data that are prepared in advance.

The camera work may include camera moves such as, for example, pan, tilt, orbit, crane, track, static, and dolly.

Pan or panning is also referred to as a panorama or connection technique, and is a technique for fixing a camera on a camera axis and filming a subject while moving the camera left and right. Panning may be used to continuously show a wide landscape by moving the camera horizontally from a fixed point of view. In general, panning may adjust the speed according to the motion of the subject when moving the camera in the horizontal direction. Moving the camera to the left is referred to as pan left, and moving the camera to the right is referred to as pan right. For example, panning may provide liveliness to a boring and dull fixed shot and may be utilized as the temporal axis connection technique.

Tilt refers to a technique of fixing a camera to a camera axis and filming a subject by moving the camera up and down in the vertical direction. Moving the camera up is referred to as tilt up, and moving the camera down is referred to as tilt down. For example, tilt may be used to show the opening of an image or a high-rise building.

Orbit refers to a technique of installing a circular track and filming a subject by moving a camera around the subject. Orbit may also be referred to as “arc”. Orbit or arc is a combination of dolly and track and refers to a technique of filming a subject while moving the camera around the subject in a semicircle. Arc may be divided into arc left and arc right depending on the direction in which the camera moves. Arc left refers to filming a subject while drawing a semicircle leftward around the subject, and arc light refers to filming a subject while drawing a semicircle rightward around the subject. Arc may arouse the interest of audiences by changing the background in various ways when showing a fixed subject from different angles.

Crane refers to a technique of filming a subject using a camera provided on a crane or jib while moving the crane or jib up and down.

Track or tracking refers to a technique of filming a subject using a camera tracking the subject that moves left and right. In this case, the camera films the subject while moving in the same direction as the subject. Track includes a scheme of filming the subject while moving the camera from right to left and a scheme of filming the subject while moving the camera from left to the right. Thus, filming may start from a different point depending on the direction in which the subject moves. Since tracking films the subject while tracking the subject that moves, a dynamic and lively image may be presented as the surrounding background changes.

Static refers to a technique of fixing a camera to a fixed device like a tripod and filming a subject without moving or manipulating the camera regardless of the motion of the subject.

Dolly refers to a technique of filming a subject by moving a camera back and forth on a moving means. Therefore, dolly needs to adjust the focus appropriately to obtain a clear image or an active image. Dolly includes filming a subject while holding a camera on a shoulder, filming a subject while holding a camera in a hand, filming a subject while lowering the camera, and it is important to film a subject without shock as much as possible.

In operation 160, the image processing apparatus outputs at least one selected from between the camera framing and the camera work. According to an example embodiment, the image processing apparatus may further output the foreground image and the background image described above, in addition to the camera framing and the camera work.

FIG. 2 illustrates a method of separating a foreground image and a background image according to an example embodiment. Referring to FIG. 2, an input image 210, and a foreground image 220 and a background image 230 obtained by separating the input image 210 are illustrated.

For example, the image processing apparatus may separate the input image 210 into the foreground image 220 and the background image 230 using a first neural network that is trained in advance. In this case, the first neural network may be trained to separate the input image 210 into a subject such as a person or a region of interest and a background image such as furniture, street, road, and the like. The first neural network may include, for example, a convolutional neural network (CNN). For example, when subjects to be separated are several people, the first neural network may be trained using person segmentation data.

The image processing apparatus may generate a foreground mask image and a background mask image by separating the input image 210 into the foreground image 220 and the background image 230 using the first neural network.

FIG. 3 illustrates a method of estimating camera framing according to an example embodiment. Referring to FIG. 3, a scene of estimating camera framing for a subject from feature points of the subject extracted from an input image is illustrated.

For example, the image processing apparatus may extract the feature points of the subject from the input image using information on the subject included in a foreground image. Here, the subject may include, for example, a person, and the feature points of the subject may include, for example, the eyes, eyebrows, nose, mouth, ears, neck, shoulders, elbows, wrists, pelvis, knees, and ankles of the person. However, the subject and the feature points of the subject are not necessarily limited thereto, and in addition, various objects may be the subject and/or the feature points of the subject. The image processing apparatus may extract feature points of the subject using information on the subject, such as identification information of the subject included in the foreground image, the position of the subject, and/or pixel coordinates corresponding to a predetermined region of the subject.

The image processing apparatus may estimate camera framing for the subject, that is, the composition of the subject, from the feature points of the subject. For example, the image processing apparatus may estimate the camera framing for the subject as close-up, bust, or waist through the positions of the face, eyes, nose, and mouth of the subject, and the proportion of other regions such as the face, bust, and waist of the subject on the screen (or the region of the subject placed on the screen).

FIG. 4 is a flowchart illustrating a method of configuring a feature vector according to an example embodiment. Referring to FIG. 4, in operation 410, an image processing apparatus may divide (partition) an optical flow map into nine areas using the rule of thirds. The rule of thirds is a type of rule of thumb used in photography, painting, or design. The rule of thirds divides a single frame into nine equal parts by two equally spaced horizontal lines and two equally spaced vertical lines and then places a subject on a virtual line or places impressive points of the screen on the four vertices where the four virtual lines meet. The rule of thirds may be used to preserve the position information of the optical flow map.

In operation 420, the image processing apparatus may configure vectors corresponding to the remaining eight areas, excluding the fifth area located in the middle, among the nine areas.

In operation 430, the image processing apparatus may generate histograms for the respective areas. The image processing apparatus may generate the histograms using direction components of the vectors for the respective areas. The image processing apparatus may generate the histograms based on the remaining pixels except for pixels having a motion size smaller than a preset criterion in the respective areas.

In operation 440, the image processing apparatus may configure a feature vector by integrating the histograms for the respective areas.

The method of configuring the feature vector using the rule of thirds by the image processing apparatus will be described in detail below with reference to FIG. 5.

FIG. 5 illustrates a method of configuring a feature vector using the rule of thirds according to an example embodiment. Referring to FIG. 5, a concentrated optical flow map 510 divided into nine areas using the rule of thirds is illustrated.

The image processing apparatus may divide the concentrated optical flow map 510 into nine areas using the rule of thirds. In this case, pixels included in the concentrated optical flow map may each have a vector including a direction and a motion size.

The image processing apparatus may configure vectors corresponding to the remaining eight areas, excluding the fifth area 530 located in the middle, among the nine areas. The image processing apparatus may generate histograms respectively corresponding to the eight areas using only direction components of the vectors corresponding to the respective eight areas. In this case, the image processing apparatus may generate the histograms while excluding pixels having a motion size smaller than a preset criterion from the respective eight areas. The image processing apparatus may configure a single feature vector by integrating the histograms for the respective eight areas.

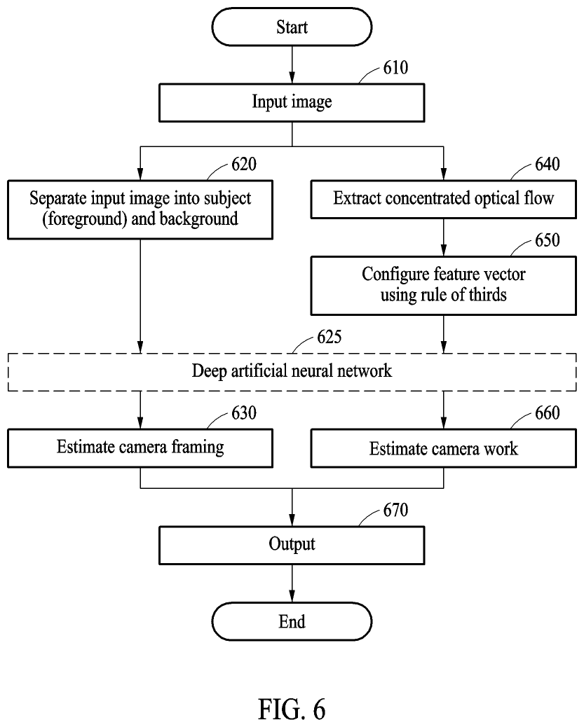

FIG. 6 is a flowchart illustrating an image processing method according to another example embodiment. Referring to FIG. 6, in operation 610, an image processing apparatus may receive an input image. The input image may be photographed or captured by the image processing apparatus, or may be photographed by an external photographing device and transmitted to the image processing apparatus through a communication interface.

In operation 620, the image processing apparatus may separate an input image into a foreground image including a subject and a background image including remaining objects except for the subject. In operation 630, the image processing apparatus may estimate camera framing for the subject through a deep artificial neural network 625 based on the input image and the foreground image.

In operation 640, the image processing apparatus may extract a concentrated optical flow map from the input image. The image processing apparatus may estimate a motion (information) between a previous frame and a current frame without prior knowledge of a frame scene by using the concentrated optical flow map. Here, the motion information is about how an object of interest is moving. The previous frame may correspond to, for example, a previous input image, and the current frame may correspond to a current input image. The previous frame and the current frame may be consecutive frames. For example, the image processing apparatus may extract the concentrated optical flow map using directions and magnitudes of pixels in the previous frame and the current frame.

In operation 650, the image processing apparatus may configure a feature vector for the concentrated optical flow map using the rule of thirds.

In operation 660, the image processing apparatus may estimate camera work through the deep artificial neural network 625. The image processing apparatus may estimate the camera work by applying the feature vector to the deep artificial neural network 625.

In operation 680, the image processing apparatus may output at least one selected from between the camera framing and the camera work.

According to an example embodiment, the camera framing estimation process of operations 620 and 630 and the camera work estimation process of operations 640 to 660 may be processed in parallel or sequentially.

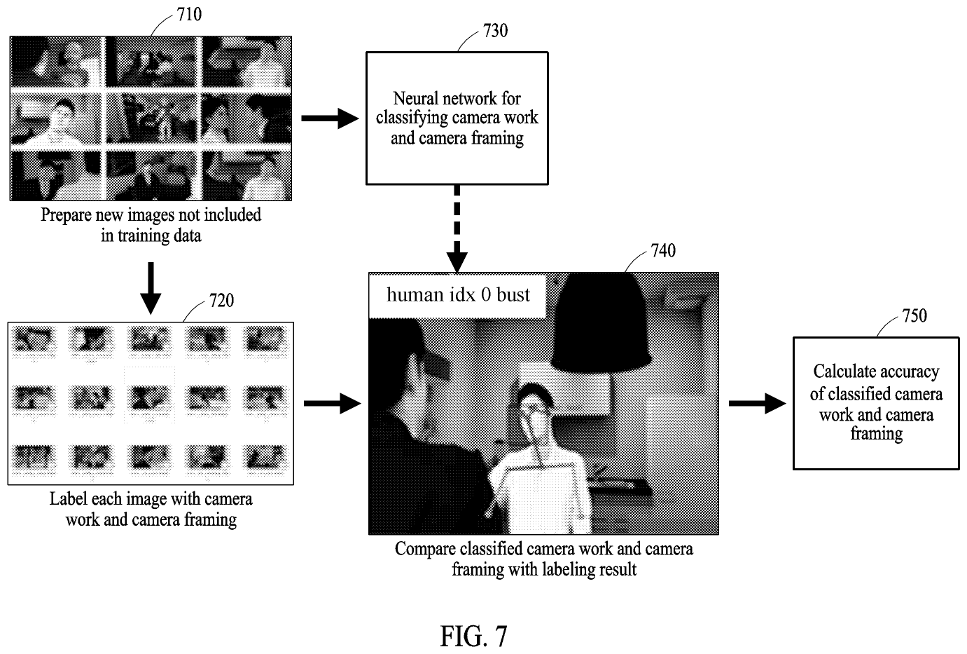

FIG. 7 illustrates a method of training a second neural network according to an example embodiment. Referring to FIG. 7, a training apparatus may include the neural network 730 for classifying camera work and camera framing. In this case, the neural network 730 may be trained in advance, for example, by the Motif CG dataset including 1,637 images, to classify camera work and camera framing corresponding to an image.

In operation 710, the training apparatus may prepare new test images (unseen images) that are not included in the training data (Motif CG dataset) used in the previous training process.

In operation 720, the training apparatus may label each of the prepared new test images with corresponding camera work and camera framing.

The training apparatus may input the prepared new test images to the trained neural network 730. In operation 740, the training apparatus may compare a result output from the neural network 730 to a result of the labeling.

In operation 750, the training apparatus may calculate the accuracy of the camera work and camera framing classified through the neural network 730 based on a result of the comparing.

The training apparatus may train the neural network 730 to improve the accuracy of camera work and camera framing.

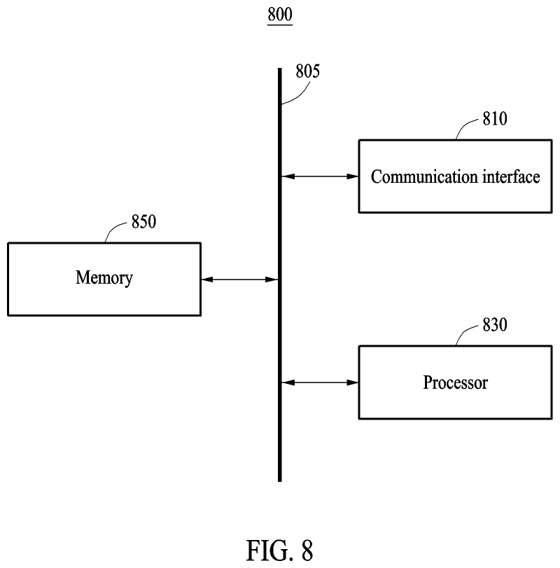

FIG. 8 is a block diagram illustrating an image processing apparatus according to an example embodiment. Referring to FIG. 8, an image processing apparatus 800 includes a communication interface 810, a processor 830, and a memory 850. The communication interface 810, the processor 830, and the memory 850 may communicate with each other through a communication bus 805.

The communication interface 810 receives an input image. In addition, the communication interface 810 outputs at least one selected from between camera framing and camera work estimated by the processor 830. The communication interface 810 may further output a foreground image and a background image obtained by separating the input image by the processor 830.

The processor 830 separates the input image into the foreground image including a subject and the background image including remaining objects except for the subject. The processor 830 estimates the camera framing for the subject based on the input image and the foreground image. The processor 830 extracts an optical flow map from the input image. The processor 830 configures a feature vector based on the optical flow map. The processor 830 estimates the camera work using the feature vector.

The processor 830 may separate the input image into the foreground image and the background image using a first neural network that is trained in advance.

The processor 830 may extract the optical flow map using a current frame corresponding to the input image and a frame previous to the current frame.

The processor 830 may divide the optical flow map into a plurality of areas using the rule of thirds. The processor 830 may generate histograms using direction components of vectors corresponding to at least one area selected from among the plurality of areas. The processor 830 may generate the histograms for the respective areas based on the remaining pixels except for pixels having a motion size smaller than a preset criterion. The processor 830 may configure the feature vector by integrating the histograms for the respective areas.

In addition, the processor 830 may perform the at least one method described with reference to FIGS. 1 through 7 or an algorithm corresponding to the at least one method. The processor 830 may be a data processing device implemented by hardware including a circuit having a physical structure to perform desired operations. For example, the desired operations may include instructions or codes included in a program. For example, the hardware-implemented data processing device may include a microprocessor, a central processing unit (CPU), a processor core, a multi-core processor, a multiprocessor, an application-specific integrated circuit (ASIC), and a field-programmable gate array (FPGA).

The processor 830 may execute a program and control the image processing apparatus 800. Program codes to be executed by the processor 830 may be stored in the memory 850.

The memory 850 may store the input image and/or the foreground image and the background image obtained by separating the input image by the processor 830. In addition, the memory 850 may store the camera framing and/or the camera work for the subject, estimated by the processor 830.

In addition, the memory 850 may store a variety of information generated in the processing process performed by the processor 830 described above. The memory 850 may store a variety of data and programs. The memory 850 may include a volatile memory or a non-volatile memory. The memory 850 may include a large-capacity storage medium such as a hard disk to store a variety of data.

The units described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. An image processing method, comprising:
separating an input image into a foreground image including a subject and a background image including remaining objects except for the subject;
estimating camera framing for the subject based on the input image and the foreground image;
extracting an optical flow map from the input image;
configuring a feature vector based on the optical flow map;
estimating camera work using the feature vector; and
outputting at least one selected from between the camera framing and the camera work.

2. The image processing method of claim 1, wherein the separating comprises separating the input image into the foreground image and the background image using a first neural network that is trained in advance.

3. The image processing method of claim 2, wherein the first neural network comprises a convolutional neural network (CNN).

4. The image processing method of claim 1, wherein the estimating of the camera framing comprises:
extracting feature points of the subject from the input image based on information on the subject included in the foreground image; and
estimating the camera framing for the subject from the feature points of the subject.

5. The image processing method of claim 4, wherein the subject comprises a person, and
the feature points of the subject comprise at least one selected from among the eyes, nose, ears, neck, shoulders, elbows, wrists, pelvis, knees, and ankles of the person.

6. The image processing method of claim 1, wherein the camera framing comprises at least one subject placement structure selected from among close-up, bust, medium, knee, full, and long.

7. The image processing method of claim 1, wherein the extracting comprises extracting the optical flow map using a current frame corresponding to the input image and a frame previous to the current frame.

8. The image processing method of claim 7, wherein pixels included in the optical flow map each have a vector including a direction and a magnitude.

9. The image processing method of claim 1, wherein the configuring comprises:
dividing the optical flow map into a plurality of areas using the rule of thirds; and
configuring the feature vector based on vectors corresponding to at least one area selected from among the plurality of areas.

10. The image processing method of claim 9, wherein the configuring of the feature vector based on the vectors comprises:
generating histograms for the respective areas using direction components of the vectors; and
configuring the feature vector by integrating the histograms for the respective areas.

11. The image processing method of claim 1, wherein the estimating of the camera work comprises estimating the camera work by applying the feature vector to a second neural network that is trained in advance.

12. The image processing method of claim 11, wherein the second neural network is trained using a plurality of training images labeled with camera framing and camera work.

13. The image processing method of claim 11, wherein the second neural network comprises a multi-layer perceptron (MLP) model.

14. The image processing method of claim 1, wherein the camera work comprises at least one camera move selected from among pan, tilt, orbit, crane, track, and static.

15. A computer program embodied on a non-transitory computer-readable medium, the computer program being configured to control a processor to perform the image processing method of claim 1.

16. An image processing apparatus, comprising:
a communication interface configured to receive an input image; and
a processor configured to separate the input image into a foreground image including a subject and a background image including remaining objects except for the subject, estimate camera framing for the subject based on the input image and the foreground image, extract an optical flow map from the input image, configure a feature vector based on the optical flow map, and estimate camera work using the feature vector,
wherein the communication interface is further configured to output at least one selected from between the camera framing and the camera work.

17. The image processing apparatus of claim 16, wherein the processor is further configured to separate the input image into the foreground image and the background image using a first neural network that is trained in advance.

18. The image processing apparatus of claim 16, wherein the processor is further configured to extract the optical flow map using a current frame corresponding to the input image and a frame previous to the current frame.

19. The image processing apparatus of claim 16, wherein the processor is further configured to divide the optical flow map into a plurality of areas using the rule of thirds, generate histograms for the respective areas using direction components of vectors corresponding to at least one area selected from among the plurality of areas, and configure the feature vector by integrating the histograms for the respective areas.
